(19) United States
(12) Patent Application Publication
(10) Pub. No.: US 2012/0158773 A1
(43) Pub. Date: Jun. 21, 2012

(54) METHOD, SYSTEM AND COMPUTER PROGRAM PRODUCT FOR ACTIVATING INFORMATION OF OBJECT COMPUTER SYSTEM

(75) Inventors: Chun-Ta Chen, Pingtung County (TW); Yu-Hung Hsueh, Kaohsiung City (TW); Sheng-An Chang, Pingtung County (TW); Yi-Hsiung Huang, Tainan City (TW); Lun-Chia Kuo, Taichung City (TW)

(73) Assignee: INDUSTRIAL TECHNOLOGY RESEARCH INSTITUTE, Hsinchu (TW)

(21) Appl. No.: 13/152,240

(22) Filed: Jun. 2, 2011

(30) Foreign Application Priority Data
Dec. 16, 2010 (TW) 99144304

(51) Int. Cl. G06F 17/30

(52) U.S. Cl. 707/769; 707/E17.014

(57) ABSTRACT

An object association system for activating associated information is provided. The system includes an environment recognition and monitor module, a feature analyzer and builder module, a feature repository, a feature matching module, and an actuator module. The environment recognition and monitor module is configured for detecting an object that is opened and extracting digital environment information and physical environment sensor information corresponding to the object. The feature analyzer and builder module is configured for generating a digital environment feature and a physical environment feature corresponding to the object, building an environment feature association model according to the digital environment feature, the physical environment feature and a text feature corresponding to the object and storing the environment feature association model in the feature repository. When the object is re-opened, the feature matching module identifies other objects related to the object, and the actuator module displays information related to the other objects.

### CROSS-REFERENCE TO RELATED APPLICATION

This application claims the priority benefit of Taiwan application serial no. 99144304, filed on Dec. 16, 2010. The entirety of the above-mentioned patent application is hereby incorporated by reference herein and made a part of this specification.

### BACKGROUND

1. Field of the Disclosure

The disclosure relates to an object association system and a method for providing supplementary information related to an opened digital file when a user opens the digital file in a computer system.

2. Description of Related Art

Along with development of information technology, today's society increasingly relies on technology and digital information, and with assistance of the information technology, people may receive various digital documents for example, multimedia and emails, etc. every day. Usage of digital information is ubiquitous from a working environment to daily life, for example, E-books, credit card billing, accounting statements, emails, and online news, etc. Therefore, assistance of digital information becomes an indispensable part of human life.

Along with a growth of computing power, the amount of information required to be processed is rapidly increased. Particularly, in an era of Web 2.0, the amount of the digital content is also greatly increased along with a booming development of personal webs share community. The Internet significantly improves information sharing speed and accelerates developments of a wide variety of IT application programs, for example, the Google email service is known for providing a large amount of email addresses, the Facebook provides the world's largest online dating community, and the Microsoft's MSN service provides instant messaging communication, etc. Under such rich and numerous information sharing channels, although people can obtain information through various channels, and can easily obtain the information with a low cost, a problem of information overload is occurred.

The information overload refers to a situation that an amount of the received data or a speed for receiving the data is excessive, which exceeds an effective information processing capability or is more than individual needs, and causes a loss of individual economy due to receptions of these unnecessary or unrelated information. Under various information bombing brought by mass communication, an individual may often have a feeling of information overload, and eventually lose the control of information.

Therefore, how to ensure the users to effectively find, use and manage digital information becomes a major issue to be developed. Particularly, people today are dealing with more complex affairs, and an individual is often responsible for multiple tasks or projects. For example, one engineer is probably in charge of two tasks of writing a research paper and developing a commercial software program, and the two tasks are probably undertook alternately, where transfer complexity of the required information is probably very high.

Presently, in a general personal computer, a method of assisting the user to find information to form a working environment mainly includes two types of keyword searching and data management interface providing.

In the first type of the method, the user input a keyword to find files containing the input keyword from the computer system. For example, the Google Desktop Search and the Windows Desktop Search are products developed according to such method. Such method requires the user to actually know what the keyword is, so as to start the searching. Moreover, the number of the searched files is probably large, and the user may spend a lot of effort to filter the searched results. Particularly, the related information is provided according to the keyword input by the user, however, when the desired file and the keyword cannot be matched in text, the searching result cannot meet the user's requirement. For example, the user has ever stored Chinese news related to American professional basketball in the computer. When the user wants to search the above data, the user probably only thinks of using a keyword “NBA” for searching, which may result in a fact that the user probably cannot find the desired data. Moreover, in the real life, some files are correlated, though they do not necessarily share the same keywords. For example, a paper text file and a spreadsheet file of experimental data, one is the text, and one is the related data, so that the keyword searching method cannot satisfy the above file association situation in real life.

The second type of the method provides a data management interface, so that the user can flexibly and regularly input data into a system. For example, a Google calendar system, a data folder system, an EverNote system, etc. are products developed according to such method. In such method, the user requires to spend a lot of time to manually arrange the information and arrange the required data for later utilization. However, since a working environment is generally switched too fast, the user has no time to organize and arrange the information before another working environment is switched. For example, when an engineer develops a program halfway through, the engineer was suddenly asked to discuss a replay comment of a conference paper. Now, it is only require a very short time for the engineer to switch from a working environment of the program development to a paper research environment, so that it probably has no enough time to arrange and organize the data during an actual application.

Therefore, when the user works in a digital environment, how to effectively and opportunely provide required supplementary information for the user is an important issue to be developed by related practitioner.

### SUMMARY OF THE DISCLOSURE

The disclosure is directed to an object association system and a method for activating associated information, which can effectively and opportunely provide related information of an object opened by a user.

The disclosure provides an object association system for activating associated information. The system includes an environment recognition and monitor module, a feature analyzer and builder module, a feature repository, a feature matching module, and an actuator module. The environment recognition and monitor module is configured for detecting an object opened in a computer system and continually extracting digital environment information and physical environment sensor information corresponding to the opened object. The feature analyzer and builder module is configured for generating a digital environment feature corresponding to the opened object according to the digital environment information thereof and generating a physical environment feature corresponding to the opened object according to the physical environment sensor information thereof, and building and updating an environment feature association model according to the digital environment feature, the physical environment feature and a text feature corresponding to the opened object. The feature repository is used for storing the environment feature association model. When the object is re-opened, the feature matching module identifies other objects related to the object according to the environment feature association model.

The disclosure provides an object association method for activating associated information. The method includes detecting and continually extracting digital environment information and physical environment sensor information corresponding to an object opened in a computer system. Moreover, the method includes generating a digital environment feature corresponding to the opened object according to the digital environment information thereof, and generating a physical environment feature corresponding to the opened object according to the physical environment sensor information thereof, and generating a text feature corresponding to the opened object according to a text content thereof. Moreover, the method includes building and updating an environment feature association model according to the digital environment feature, the physical environment feature and the text feature corresponding to the opened object, and storing the environment feature association model. Moreover, the method includes identifying other objects related to the object according to the environment feature association model when the object is re-opened in the computer system.

The disclosure provides a computer system including a central processor, a random access memory, a storage device, an input device, a display device, a sensing device, an operating system and an object association system. The operating system and the object association system are stored in the storage device and are executed by the central processor. The object association system includes an environment recognition and monitor module, a feature analyzer and builder module, a feature repository, a feature matching module, and an actuator module. The environment recognition and monitor module is configured for detecting an object opened in a computer system and continually extracting digital environment information and physical environment sensor information corresponding to the opened object. The feature analyzer and builder module is configured for generating a digital environment feature corresponding to the opened object according to the digital environment information thereof and generating a physical environment feature corresponding to the opened object according to the physical environment sensor information thereof, and building and updating an environment feature association model according to the digital environment feature, the physical environment feature and a text feature corresponding to the opened object. The feature repository is used for storing the environment feature association model. When the object is re-opened, the feature matching module identifies other objects related to the object according to the environment feature association model.

According to an exemplary embodiment of the present disclosure, a computer program product is provided. The computer program product includes a plurality of program instructions, and the program instructions are suitable for being loaded into a computer system to execute the aforementioned object association method for activating associated information.

According to the above descriptions, in the exemplary embodiment of the disclosure, related objects can be provided to the user for reference according to the digital environment feature, the physical environment feature and the text feature corresponding to an object opened by the user, so as to greatly shorten a time for searching the required information.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is an operation schematic diagram of an object association system for activating associated information according to an exemplary embodiment of the disclosure.

FIG. 2 is a schematic block diagram of an object association system according to an exemplary embodiment of the disclosure.

FIG. 3 is a flowchart illustrating a method of extracting a text feature according to an exemplary embodiment of the disclosure.

FIG. 4 is an example of a phrase association table according to an exemplary embodiment of the disclosure.

FIG. 5 is a schematic diagram illustrating an environment feature association model according to an exemplary embodiment of the disclosure.

FIG. 6 is a flowchart illustrating a method of searching related objects according to a common working object field of an environment feature association model according to an exemplary embodiment of the disclosure.

FIG. 7 is a flowchart illustrating a method of searching related objects according to text features of an environment feature association model according to an exemplary embodiment of the disclosure.

FIG. 8 is a flowchart illustrating a method of searching related objects according to sensing coordinates of an environment feature association model according to an exemplary embodiment of the disclosure.

FIG. 9 is a schematic diagram of information actuation according to another exemplary embodiment of the disclosure.

FIG. 10 is a flowchart illustrating an object association method for activating associated information according to an exemplary embodiment of the disclosure.

### DETAILED DESCRIPTION OF DISCLOSED EMBODIMENTS

The disclosure provides an object association system for activating associated information, which can detect an object opened in a computer system and continually extract digital environment information and physical environment sensor information corresponding to the object. Moreover, the system can also generate a digital environment feature and a physical environment feature corresponding to the opened object according to the digital environment information and the physical environment sensor information thereof, and builds and stores an environment feature association model according to the digital environment feature, the physical environment feature and a text feature corresponding to the opened object. Particularly, when the object is re-opened in the computer system, the system may display reference information of other objects related to the object according to the stored environment feature association model for user's reference. An exemplary embodiment is provided below with reference of figures to describe the object association system of the disclosure in detail.

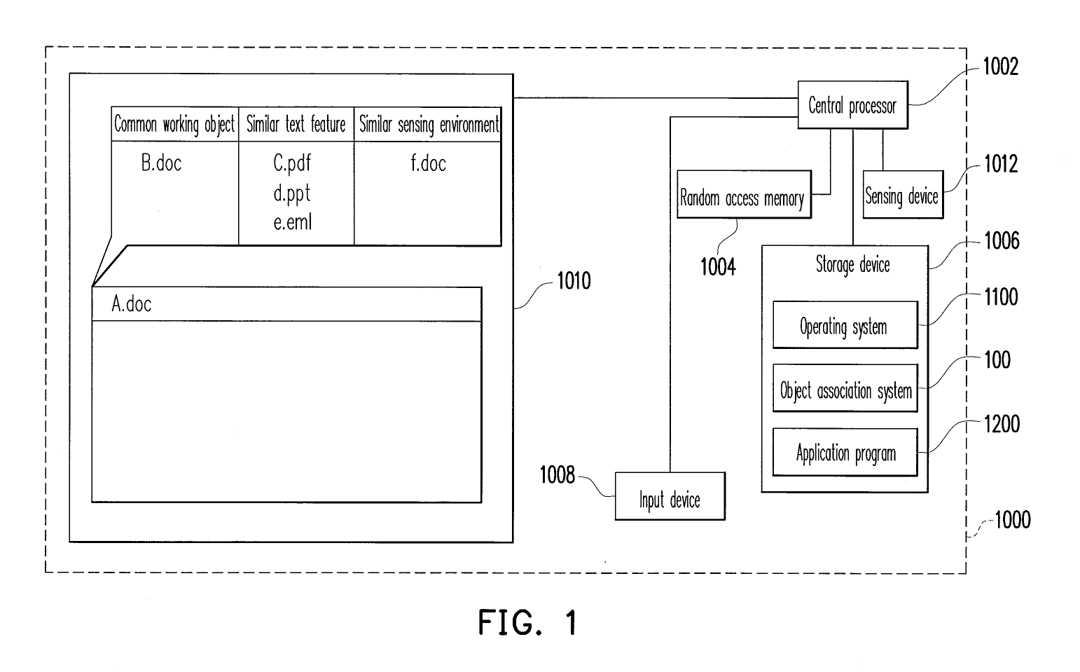

FIG. 1 is an operation schematic diagram of an object association system for activating associated information according to an exemplary embodiment of the disclosure.

Referring to FIG. 1, the object association system for activating the associated information (which is referred to as the object association system 100 hereinafter) can be executed in a computer system 1000. In detail, the computer system 1000 includes a central processor 1002, a random access memory 1004, a storage device 1006, an input device 1008, a display device 1010 and a sensing device 1012. The object association system 100 is stored in the storage device 1006 in form of program codes, and when the program codes are loaded into the random access memory 1004 and are executed by the central processor 1002, the computer system 1000 can execute all functions of the object association system 100.

Here, the object association system 100 executed on a personal computer is taken as an example for description, though it should be noticed that the computer system 1000 can also be a personal digital assistant, a mobile electronic device or other data processing devices.

The computer system 1000 is installed with an operating system 1100 and an application program 1200, and the user can open an object through the operating system 1000 and the application program 1200 to execute a related task. For example, the user may use a file editing application program, an email application program, a briefing making application program, etc. to edit text files. Here, objects belonged to such text files are taken as an example to describe the operation of the object association system 100. However, it should be noticed that the object mentioned in the disclosure can also be a software programming language complier file, an audio and video file, a music file and metadata, etc.

During an operation period of the computer system 1000, the object association system 100 can continually monitor an object (for example, a text file) opened by the operating system 1100, and collect digital environment information corresponding to the opened object. For example, the digital environment information includes information about other objects (for example, a certain website, a certain email, a certain briefing file or another document file) simultaneously opened in the computer system 1000 during a period when the object is opened. Moreover, the object association system 100 may collect physical environment sensor information received by the sensing device during the period when the object is opened. Therefore, the object association system 100 may build a digital environment feature and a physical environment feature corresponding to the opened object according to the digital environment information and the physical environment sensor information thereof, and build a text feature corresponding to the opened object according to contents thereof.

Therefore, after the object association system 100 continually extracts features of a plurality of objects opened in the computer system 1000 and accordingly establishes an environment feature association model, when the objects are re-opened, the object association system 100 can search the other objects related to the opened objects according to the information in the environment feature association model, and display reference information of the related objects on the display device 1010 for user's reference or directly opening the object to be operated through the displayed interface.

For example, as shown in FIG. 1, when an user opens a file with a file name of A.doc (which is referred to as an object A.doc hereinafter), the object association system 100 displays an object B.doc probably simultaneously used by the user, objects C.pdf, d.ppt and e.eml having the same text feature with that of the object A.doc, and an object f.doc having a similar physical environment feature with that of the object A.doc in the display device 1010 according to the environment feature association model. In this way, the user can quickly find the required file according to the reference information of the related objects provided by the object association system 100.

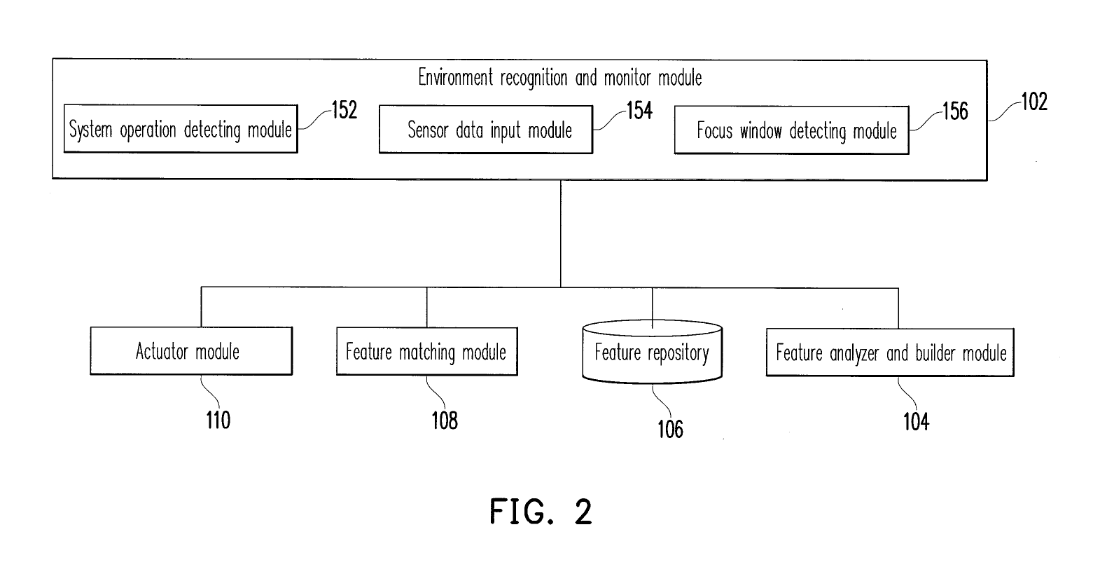

FIG. 2 is a schematic block diagram of an object association system according to an exemplary embodiment of the disclosure.

Referring to FIG. 2, the object association system 100 includes an environment recognition and monitor module 102, a feature analyzer and builder module 104, a feature repository 106, a feature matching module 108, and an actuator module 110.

The environment recognition and monitor module 102 is configured for detecting an object opened in the computer system 1000 and continually extracting digital environment information and physical environment sensor information corresponding to the object.

For example, the environment recognition and monitor module 102 includes a system operation detecting module 152, a sensor data input module 154 and a focus window detecting module 156.

The system operation detecting module 152 is configured for detecting an object (for example, the object A.doc shown in FIG. 1) opened in the computer system 1000 and other objects simultaneously opened together with the object. In detail, when an user edits a certain document file, the user may also open other document files, websites or emails for reference. For example, when the object A.doc is opened, the user may also open the object B.doc, the object C.pdf, and the object f.doc, etc. The system operation detecting module 152 detects the opened objects and extracts related attributes thereof (for example, file paths, etc.).

The sensor data input module 154 is configured for receiving the physical environment sensor information corresponding to the opened object from the sensing device 1012. For example, in the present exemplary embodiment, the sensing device 1012 includes a positioning device, and the sensor data input module 154 receives coordinate data or location information from the positioning device. Particularly, the sensor data input module 154 takes the coordinate data or the location information as the physical environment sensor information of the opened object. In detail, when an user always opens a plurality files at the same location, these files are probably associated. For example, the user may open a plurality of briefing files or document files at a certain client office. In the present exemplary embodiment, the positioning device supports a global positioning system (GPS) and receives location information from a plurality of satellites to calculate coordinate information of a corresponding geographic address. However, it should be noticed that the disclosure is not limited thereto, and in another exemplary embodiment of the disclosure, the positioning device may also be a geographic coordinate detection device supporting a Galileo positioning system, a global navigation satellite system (GLONASS), or an assisted global positioning system (AGPS).

The focus window detecting module 156 is configured for continually detecting a focus window in the computer system 1000. Here, the focus window refers to an object on a desktop (i.e. the display frame of FIG. 1) of the operating system 1100 that is currently operated by the user through the input device 1008, which is also referred to as an on-top window.

The feature analyzer and builder module 104 is configured for generating a digital environment feature and a physical environment feature corresponding to the opened object according to the digital environment information and the physical environment sensor information thereof.

In the present exemplary embodiment, the feature analyzer and builder module 104 calculates focus switching times and switching time intervals between the opened object and the other simultaneously opened objects according to the focus window detected by the focus window detecting module 156, and identifies a common working object corresponding to the opened object according to the focus switching times and the switching time intervals between the opened object and the other simultaneously opened objects. For example, the feature analyzer and builder module 104 takes the focus switching times between two objects divided by a total switching times between the current objects as an assessment value of the two objects mutually serving as the common working objects. Moreover, the feature analyzer and builder module 104 determines whether the two objects are the common working objects according to the assessment value and the switching time interval of the two objects.

For example, it is assumed that in the computer system 1000, the object A.doc, the object B.doc, the object C.pdf and the object f.doc are all in an opened state, and the focus window detecting module 156 detects that the object A.doc becomes the current focus window at 10:10; the object B.doc becomes the focus window at 10:10; the object A.doc becomes the focus window at 10:15 again; the object B.doc becomes the focus window at 10:20 again; the object C.pdf becomes the focus window at 11 o'clock; and the object f.doc becomes the focus window at 11:05. In this exemplary embodiment, the feature analyzer and builder module 104 may analyse that the focus switching times between the object A.doc and the object B.doc is 3, a total switching times of the current objects is 5, and an average switching time interval thereof is 5 minutes. Therefore, an assessment value between the object A.doc and the object B.doc mutually serving as the common working objects is 0.6 (=⅗). Moreover, the feature analyzer and builder module 104 analyses that a focus switching times between the object B.doc and the object C.pdf is 1, the total switching times of the current objects is 5, and an average switching time interval thereof is 40 minutes. Therefore, an assessment value between the object B.doc and the object C.pdf mutually serving as the common working objects is 0.2 (=⅕). Moreover, the feature analyzer and builder module 104 analyses that a focus switching times between the object C.pdf and the object f.doc is 1, the total switching times of the current objects is 5, and an average switching time interval thereof is 5 minutes. Therefore, an assessment value between the object C.pdf and the object f.doc mutually serving as the common working objects is 0.2 (=⅕). In this way, the feature analyzer and builder module 104 may determine that the object A.doc and the object B.doc are mutual common working objects according to the assessment values and the average time intervals.

Particularly, in the present exemplary embodiment, the feature analyzer and builder module 104 takes the common working object of the opened object as the digital environment feature thereof.

Moreover, the feature analyzer and builder module 104 establishes the physical environment feature of the opened object according to the coordinate data received by the sensor data input module 154. For example, the feature analyzer and builder module 104 records the coordinate data received by the sensor data input module 154 when the object is opened, and takes the coordinate data as the physical environment feature of the opened object. It should be noticed that in another exemplary embodiment of the disclosure, the feature analyzer and builder module 104 may also first convert such coordinate data into a location or a nearby location marked on the map, and then takes the location as the physical environment feature of the opened object. For example, the feature analyzer and builder module 104 maps the received coordinate data as “industrial technology research institute”, which represents that the object is opened by the user at the industrial technology research institute.

In the exemplary embodiment of the disclosure, the feature analyzer and builder module 104 is further configured for extracting a text feature from the opened object. In detail, the feature analyzer and builder module 104 performs a word segmentation operation on text contents of the opened object to generate a plurality of phrases. Particularly, the feature analyzer and builder module 104 generates the text feature corresponding to the opened object according to a feature weight of each of the phases in the text content thereof.

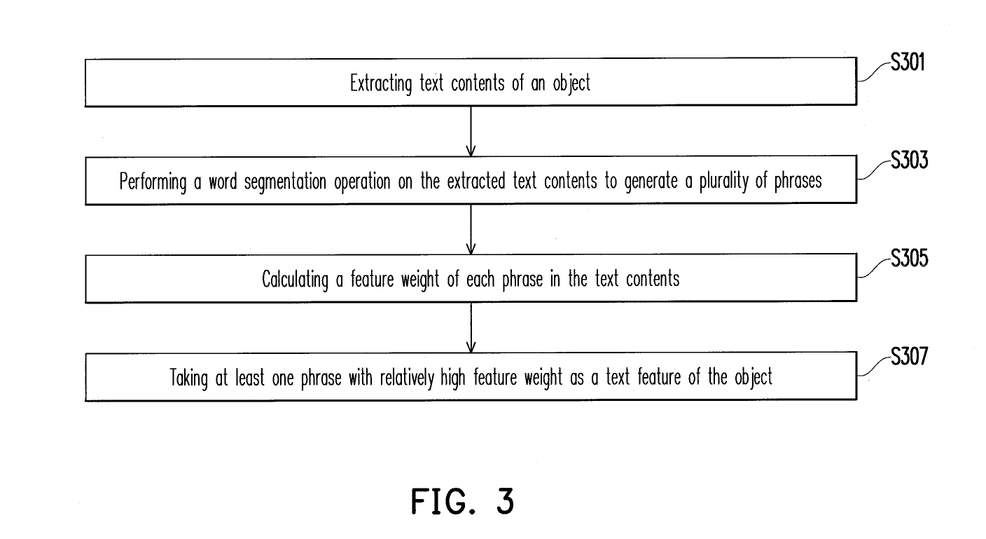

FIG. 3 is a flowchart illustrating a method of extracting the text feature according to an exemplary embodiment of the disclosure.

Referring to FIG. 3, in step S301, the feature analyzer and builder module 104 extracts the text content of the object (for example, important text or paragraphs). Then, in step S303, the feature analyzer and builder module 104 performs the word segmentation operation on the extracted text content to generate a plurality of phrases. Moreover, in step S305, the feature analyzer and builder module 104 calculates a feature weight of each of the phrases in the extracted text content. For example, in the step S305, the feature analyzer and builder module 104 calculates a feature weight of each phrase according to an occurrence times and an occurrence time of the phrase through a following equation:

$$Ferquency ( T ) = {\sum }_{i = 1}^{N} \frac{1}{D ( i ) + 1} \times Number ( i , T )$$

Where, Frequency (T) represents a feature weight of a phrase T, N represents a number of days from when the object association system 100 is initially started until a current time point, D(i) represents a time interval between the current time point and an i^{th} day from when the object association system 100 is initially started, and Number (i,T) represents occurrence times of the phrase T in the i^{th} day after the object association system 100 is initially started.

Referring to FIG. 3, in step S307, the feature analyzer and builder module 104 takes at least one phrase with relatively high feature weight as the text feature of the object. Here, the number of the selected phrases may be adjusted according to a system setting or according to an average threshold of frequency.

For example, after the word segmentation operation, if it is analysed that the phrase with the highest feature weight in the object A.doc is “OP22 patent”, the feature analyzer and builder module 104 takes “OP22 patent” as one of the text features of the object A.doc.

It should be noticed that besides taking the text with relatively high feature weight as the text feature, in another exemplary embodiment of the disclosure, the feature analyzer and builder module 104 may record the phrases in the text content of the analysed object and determine a phrase associated with the phrase of the highest feature weight by using a support degree and a confidence index between the phrases, and takes the associated phrase as the text feature. Here, the support degree and the confidence index between the phrases are calculated according to following equations:

Support(T1,T2)=DNumber(T1,T2)/TotalD

Confidence(T1,T2)=DNumber(T1,T2)/DNumber(T1)

Where, Support(T1,T2) represents a support degree between a phrase T1 and a phrase T2, DNumber(T1,T2) represents the number of the objects simultaneously having the phrase T1 and the phrase T2 in the analysed objects, TotalD represents the number of the analysed objects, Confidence(T1,T2) represents a confidence index between the phrase T1 and the phrase T2, and DNumber(T1) represents the number of the objects having the phrase T1 in the analysed objects. When the support degree and the confident index between the phrase T1 and the phrase T2 are respectively greater than a corresponding predetermined threshold, the phrase T2 is regarded as an associated phrase of the phrase T1.

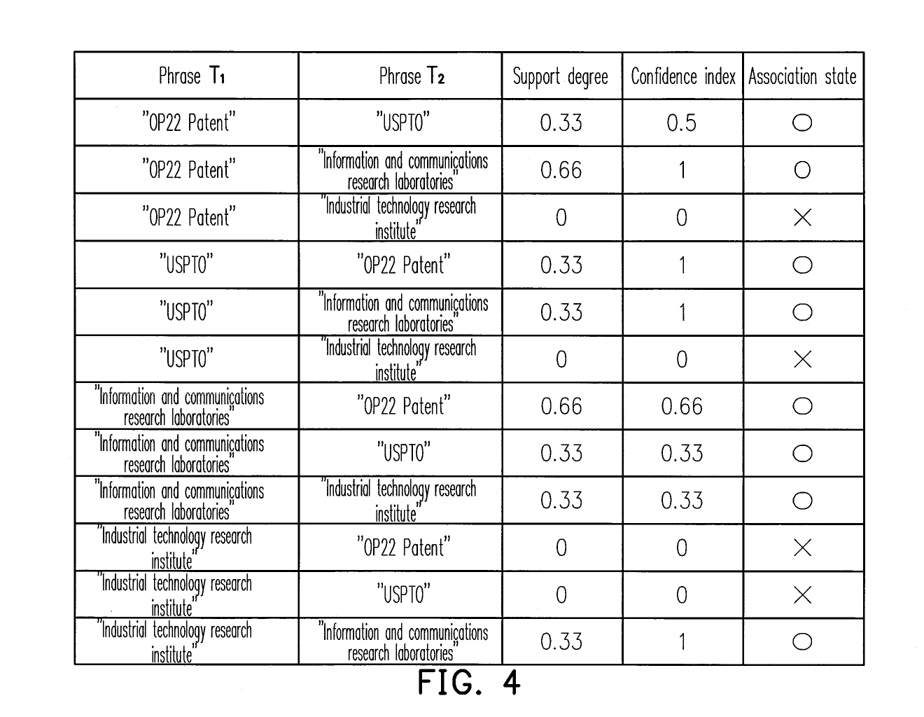

For example, in an exemplary embodiment, the object A.doc includes phrases of “OP22 patent”, “USPTO” and “information and communications research laboratories”, etc; an object d.ppt includes phrases of “OP22 patent” and “information and communications research laboratories”, etc; and an object e.eml includes phrases of “information and communications research Laboratories” and “industrial technology research institute”, etc., and the support degree and the confident index are respectively set to 0.25. In this exemplary embodiment, the feature analyzer and builder module 104 calculates the support degree and the confident index of a certain phrase associated with another phrase, and determines whether the association is successful, so as to generate a phrase association table (shown in FIG. 4).

FIG. 4 is an example of a phrase association table according to an exemplary embodiment of the disclosure.

Referring to FIG. 4, in the present exemplary embodiment, a support degree and a confident index associated from “OP22 patent” to “USPTO” are respectively 0.33 and 0.5; a support degree and a confident index associated from “OP22 patent” to “information and communications research laboratories” are respectively 0.66 and 1; a support degree and a confident index associated from “OP22 patent” to “industrial technology research institute” are respectively 0 and 0; a support degree and a confident index associated from “USPTO” to “OP22 patent” are respectively 0.33 and 1; a support degree and a confident index associated from “USPTO” to “information and communications research laboratories” are respectively 0.33 and 1; a support degree and a confident index associated from “USPTO” to “industrial technology research institute” are respectively 0 and 0; a support degree and a confident index associated from “information and communications research laboratories” to “OP22 patent” are respectively 0.66 and 0.66; a support degree and a confident index associated from “information and communications research laboratories” to “USPTO” are respectively 0.33 and 0.33; a support degree and a confident index associated from “information and communications research laboratories” to “industrial technology research institute” are respectively 0.33 and 0.33; a support degree and a confident index associated from “industrial technology research institute” to “OP22 patent” are respectively 0 and 0; a support degree and a confident index associated from “industrial technology research institute” to “USPTO” are respectively 0 and 0; and a support degree and a confident index associated from “industrial technology research institute” to “information and communications research laboratories” are respectively 0.33 and 1.

Therefore, according to the phrase association table of FIG. 4, when the phrase “OP22 patent” is selected as a text feature of a certain object, the associated phrases “information and communications research laboratories” and “industrial technology research institute”, etc. are also set as the text features of the object. Similarly, when the phrase “USPTO” is selected as a text feature of a certain object, the associated phrases “OP22 patent” and “information and communications research laboratories”, etc. are also set as the text features of the object. When the phrase “information and communications research laboratories” is selected as a text feature of a certain object, the associated phrases “OP22 patent” and “USPTO” and “industrial technology research institute”, etc. are also set as the text features of the object. When the phrase “industrial technology research institute” is selected as a text feature of a certain object, the phrase “information and communications research laboratories” is also set as the text feature of the object.

It should be noticed that it is only an example to select the association phrases according to the support degree and the confidence index to serve as the text feature, and the disclosure is not limited thereto. In another exemplary embodiment of the disclosure, the feature analyzer and builder module 104 can also use other methods to select the association phrases.

In the exemplary embodiment of the disclosure, the feature analyzer and builder module 104 builds and updates an environment feature association model according to the digital environment feature, the physical environment feature and the text feature of the corresponding object, and stores the environment feature association module in the feature repository 106.

In detail, after the object association system 100 is started, the environment recognition and monitor module 102 continually detects and extracts digital environment information and physical environment sensor information corresponding to objects. Moreover, the feature analyzer and builder module 104 continually receives the digital environment information and the physical environment sensor information and generates the digital environment feature, the physical environment feature, and the text feature corresponding to the objects. Particularly, the feature analyzer and builder module 104 records the digital environment feature, the physical environment feature and the text feature corresponding to the analysed object into the environment feature association model, and continually updates the environment feature association model.

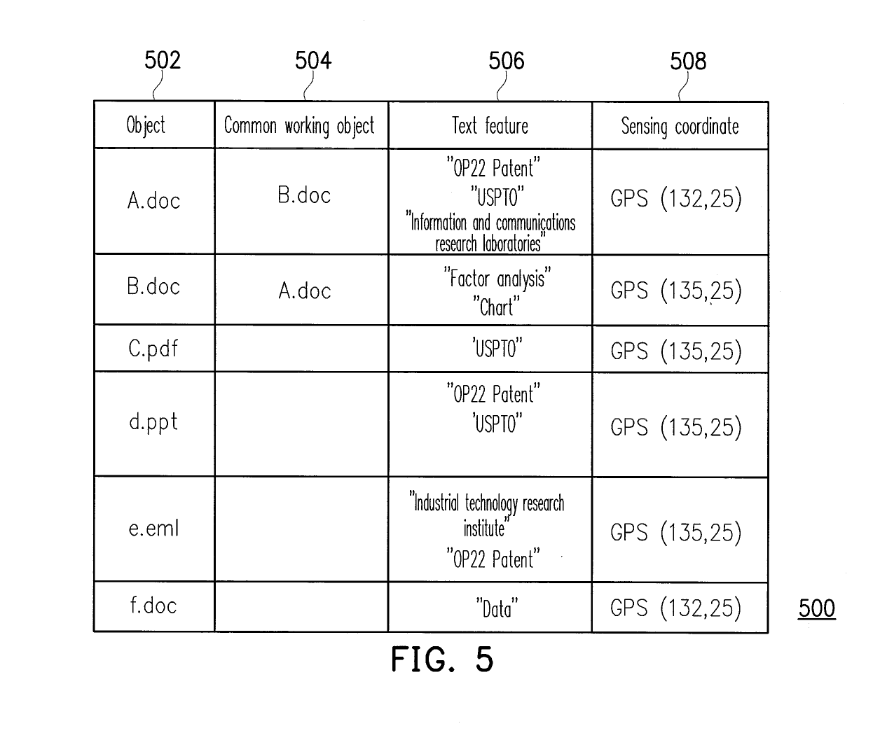

FIG. 5 is a schematic diagram illustrating an environment feature association model according to an exemplary embodiment of the disclosure.

Referring to FIG. 5, the environment feature association model 500 includes an object field 502, a common working object field 504, a text feature field 506 and a sensing coordinate field 508. For example, the common working object of the object A.doc is B.doc, the text features of the object A.doc are “OP22 patent”, “USPTO” and “information and communications research laboratories”, and the sensing coordinate of the object A.doc is “GPS(132,25)”.

Referring to FIG. 2 again, when an object is opened, the feature matching module 108 identifies other objects related to the object (referred to as related objects hereinafter) according to the environment feature association model 500 stored in the feature repository 106.

For example, the feature matching module 108 takes the common working object corresponding to the opened object in the environment feature association model as the related object of the opened object.

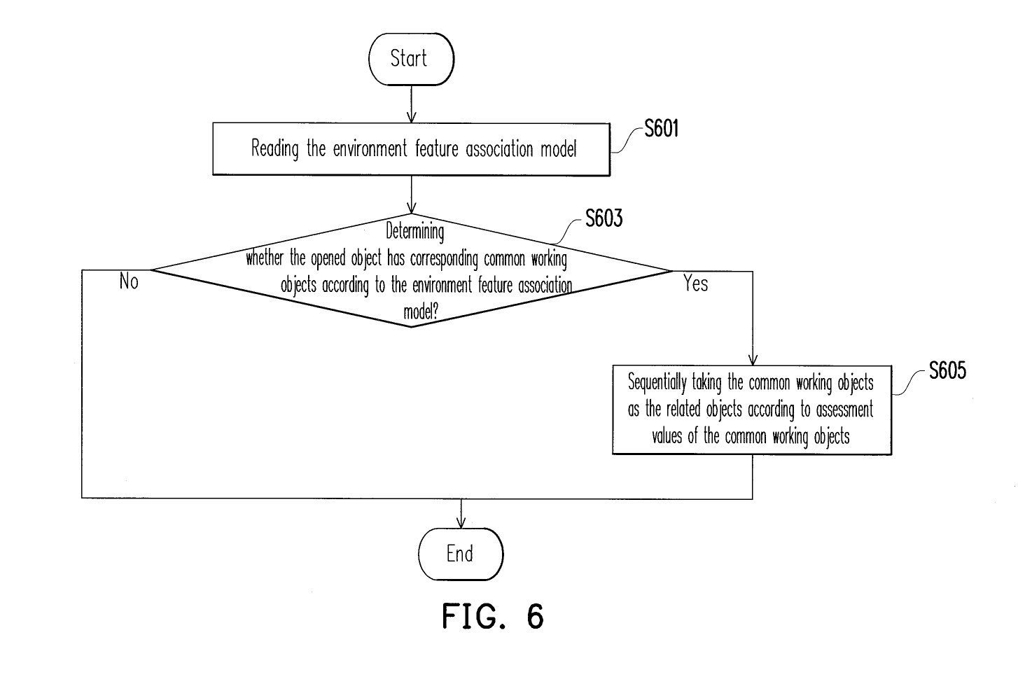

FIG. 6 is a flowchart illustrating a method of searching the related objects according to the common working object field of the environment feature association model according to an exemplary embodiment of the disclosure.

Referring to FIG. 6, in step S601, the feature matching module 108 reads the environment feature association model 500 from the feature repository 106, and in step S603, the feature matching module 108 determines whether the opened object has a corresponding common working object according to the environment feature association model 500. If the opened object has the corresponding common working object, in step S605, the feature matching module 108 sequentially takes the common working objects as the related objects according to assessment values (i.e. correlation degrees) of the common working objects.

In the present exemplary embodiment of the disclosure, the feature matching module 108 may also search other objects having the same text features as those of the opened object in the environment feature association model to serve as the related objects.

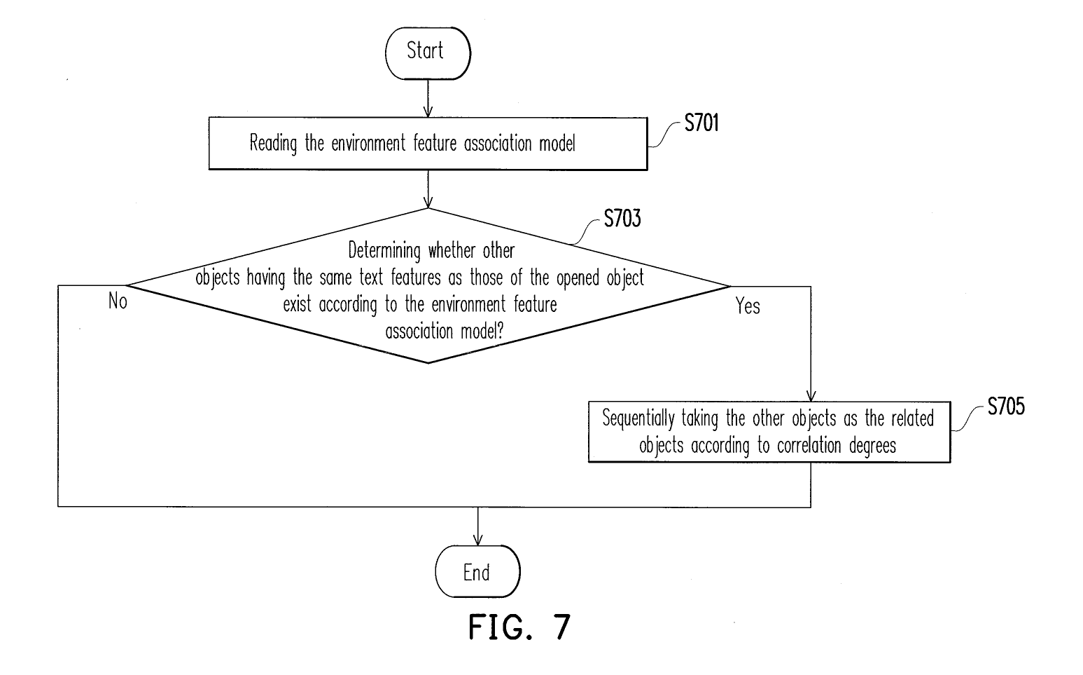

FIG. 7 is a flowchart illustrating a method of searching the related objects according to the text features of the environment feature association model according to an exemplary embodiment of the disclosure.

Referring to FIG. 7, in step S701, the feature matching module 108 reads the environment feature association model 500 from the feature repository 106. In step S703, the feature matching module 108 determines whether other objects having the same text features as those of the opened object exist according to the environment feature association model 500. If the other objects with the same text features as those of the opened object exist, in step S705, the feature matching module 108 sequentially takes the other objects as the related objects according to correlation degrees (for example, the number of the same text features) thereof.

In the exemplary embodiment of the disclosure, the feature matching module 108 may also search other objects having the same sensing coordinates as the sensing coordinates of the opened object in the environment feature association model to serve as the related objects.

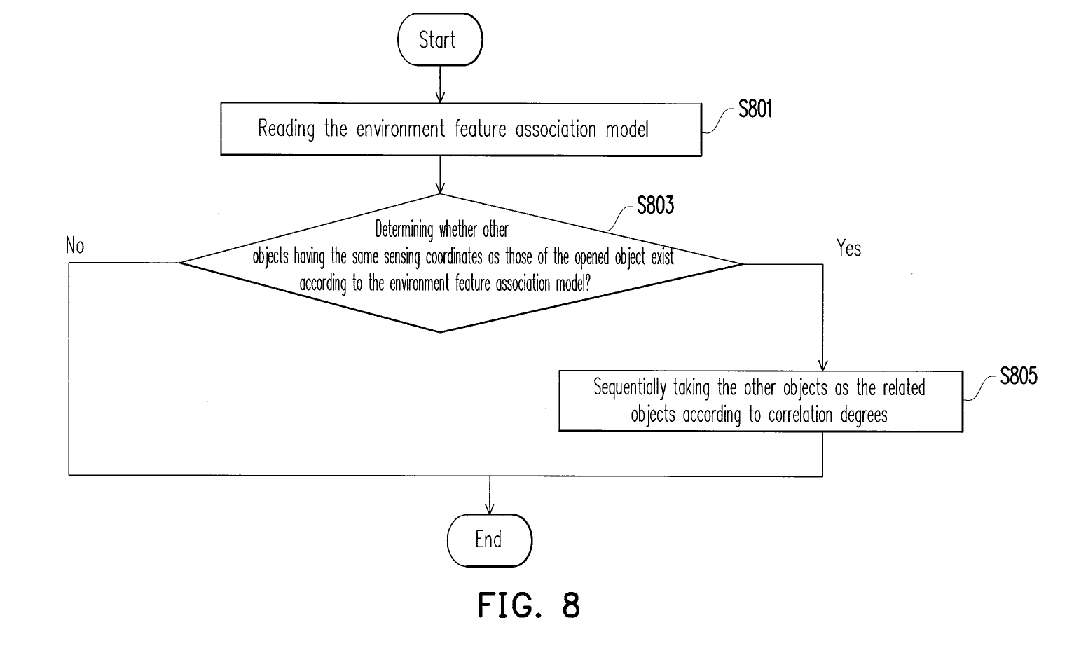

FIG. 8 is a flowchart illustrating a method of searching the related objects according to the sensing coordinates of the environment feature association model according to an exemplary embodiment of the disclosure.

Referring to FIG. 8, in step S801, the feature matching module 108 reads the environment feature association model 500 from the feature repository 106. In step S803, the feature matching module 108 determines whether other objects having the same sensing coordinates as those of the opened object exist according to the environment feature association model 500. If the other objects having the same sensing coordinates as those of the opened object exist, in step S805, the feature matching module 108 sequentially takes the other objects as the related objects according to correlation degrees (for example, magnitude of distances) thereof.

Referring to FIG. 2 again, when the object is opened, the actuator module 110 generates and displays related object reference information (shown in FIG. 1) according to the related objects searched by the feature matching module 108.

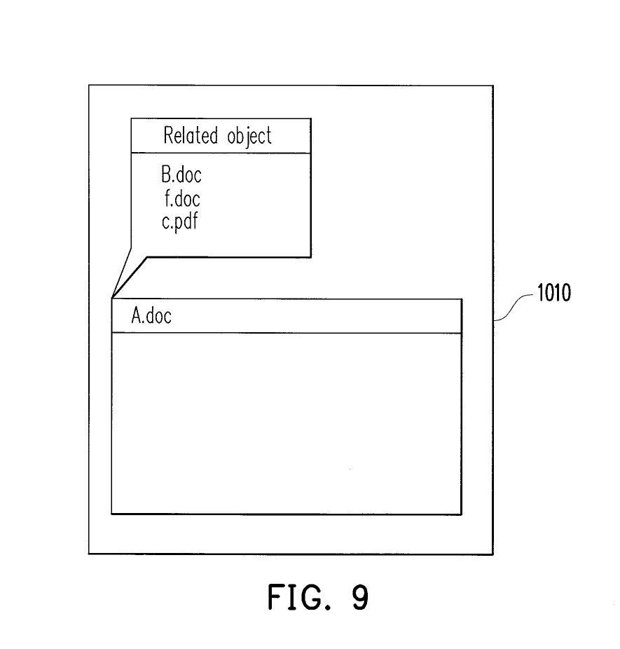

It should be noticed that in the present exemplary embodiment, the feature matching module 108 searches the related objects respectively according to the digital environment feature (for example, the common working object), the text feature and the physical environment feature (for example, the sensing coordinates) in the environment feature association model. However, in another exemplary embodiment of the disclosure, the feature matching module 108 can also search the related objects by simultaneously considering the digital environment feature, the physical environment feature and the text feature in the environment feature association model according to a weight of each of the features. For example, the weights of the digital environment feature, the physical environment feature and the text feature in the environment feature association model are respectively 50%, 30% and 20%. In this case, as shown in FIG. 9, the actuator module 110 integrally provides information of the related objects other than providing the information according to respective features.

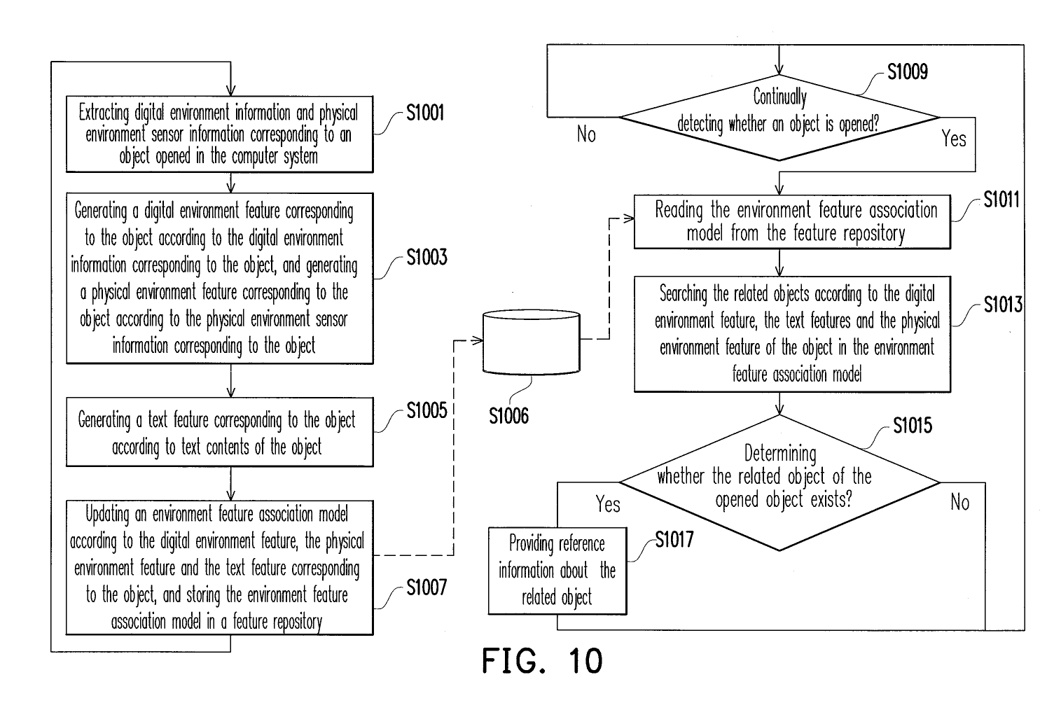

FIG. 10 is a flowchart illustrating an object association method for activating associated information according to an exemplary embodiment of the disclosure.

Referring to FIG. 10, in step S1001, the environment recognition and monitor module 102 extracts digital environment information and physical environment sensor information corresponding to an object opened in the computer system 1000.

In step S1003, the feature analyzer and builder module 104 generates a digital environment feature corresponding to the opened object according to the digital environment information thereof, and generates a physical environment feature corresponding to the opened object according to the physical environment sensor information thereof. Moreover, in step S1005, the feature analyzer and builder module 104 generates a text feature corresponding to the opened object according to text contents thereof. The method of generating the digital environment feature and the physical environment feature and the method of generating the text feature in the step S1003 and the step S1005 have been described above, so that detailed descriptions thereof are not repeated.

Then, in step S1007, the feature analyzer and builder module 104 updates an environment feature association model according to the digital environment feature, the physical environment feature and the text feature corresponding to the object, and stores the environment feature association model in the feature repository 106. It should be noticed that the steps S1001, S1003, S1005 and S1007 can be repeatedly executed after the object association system 100 is started, so as to continually update the environment feature association model.

On the other hand, in step S1009, the environment recognition and monitor module 102 continually detects whether an object is opened. When a certain object (for example, the object A.doc) is opened in the computer system 1000, in step S1011, the feature matching module 108 reads the environment feature association model from the feature repository 106. Then, in step S1013, the feature matching module 108 searches the related objects according to the digital environment feature, the text features and the physical environment feature of the object in the environment feature association model. The method of searching the related objects in the step S1013 have been described above, so that the detailed description thereof is not repeated.

Then, in step S1015, the actuator module 110 determines whether the related object of the opened object exists. If the related object exists, in step S1017, the actuator module 110 provides reference information about the related object. For example, the reference information of the related object is displayed on the desktop. Then, the flow is returned to the step S1009 to continually detect whether an object is opened.

It should be noticed that besides the association between the objects, in another exemplary embodiment of the disclosure, the system operation detecting module 152 of the environment recognition and monitor module 102 may further detect an environment setting of the operating system 1100 when the object is opened. For example, the environment setting includes the screen brightness and the speaker volume of the computer system 1000, etc. Particularly, the feature analyzer and builder module 104 may generate the digital environment feature according to the environment setting, and when the user again opens the object later, the actuator module 110 may provide reference information of the related environment setting to the user, so as to facilitate the user to quickly switch the operation environment.

In addition, the computer program product is stored in a computer-readable recording medium and subsequently read by a computer system, wherein the computer-readable recording medium may be any data storage medium. The computer-readable recording medium may be a read-only memory (ROM), a random-access memory (RAM), a CD-ROM, a magnetic tape, a floppy disc, or an optical data storage device.

In summary, in the exemplary embodiment of the disclosure, related objects can be provided to the user for reference according to the digital environment feature, the physical environment feature and the text feature corresponding to the object opened by the user, so as to greatly shorten the time for searching the required information. Moreover, when the user opens the object, information of the related environment setting for operating the object is provided to the user, so that the user can quickly configure the required environment setting.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. An object association system for activating associated information, comprising:
an environment recognition and monitor module, configured for detecting an object opened in a computer system, and continually extracting digital environment information and physical environment sensor information corresponding to the object;
a feature analyzer and builder module, configured for generating a digital environment feature corresponding to the object according to the digital environment information corresponding to the object, generating a physical environment feature corresponding to the object according to the physical environment sensor information corresponding to the object, and building an environment feature association model according to the digital environment feature, the physical environment feature and a text feature corresponding to the object
a feature repository, configured for storing the environment feature association model; and
a feature matching module, configured for identifying at least one related object related to the object according to the environment feature association model when the object is re-opened.

2. The object association system for activating associated information as claimed in claim 1, further comprising:
an actuator module, configured for generating and displaying related object reference information according to the at least one related object when the object is re-opened.

3. The object association system for activating associated information as claimed in claim 1, wherein the environment recognition and monitor module comprises:
a system operation detecting module, configured for detecting the object opened in the computer system and at least another object simultaneously opened together with the object;
a sensor data input module, configured for receiving the physical environment sensor information corresponding to the object from at least one sensing device; and
a focus window detecting module, configured for continually detecting a focus window in the computer system,
wherein the feature analyzer and builder module calculates focus switching times and a switching time interval between the object and the at least one other object according to the detected focus window, and identifies at least one common working object corresponding to the object according to the focus switching times and the switching time interval between the object and the at least one other object,
wherein the feature analyzer and builder module generates the digital environment feature according to the at least one common working object.

4. The object association system for activating associated information as claimed in claim 3, wherein the at least one sensing device at least comprises a positioning device configured for generating coordinate data or location information,
wherein the feature analyzer and builder module takes the coordinate data or the location information received by the sensor data input module when the object is opened as the physical environment feature corresponding to the object.

5. The object association system for activating associated information as claimed in claim 1, wherein the feature analyzer and builder module performs a word segmentation operation on text contents of the object to generate at least one phrase, and generates the text feature corresponding to the object according to a feature weight of each of the phases in the text contents of the object.

6. The object association system for activating associated information as claimed in claim 1, wherein the feature analyzer and builder module performs a word segmentation operation on text contents of the object to generate a plurality of phrases, and generates the text feature corresponding to the object according to a feature weight of each of the phases in the text contents of the object and at least one associated phrase,
wherein the at least one associated phrase of each of the phrases is determined according to a minimum support degree and a minimum confidence index between the phrases.

7. The object association system for activating associated information as claimed in claim 3, wherein the feature matching module identifies the at least one related object related to the object in the environment feature association model according to the at least one common working object corresponding to the object.

8. The object association system for activating associated information as claimed in claim 5, wherein the feature matching module identifies the at least one related object related to the object in the environment feature association model according to the text feature corresponding to the object.

9. The object association system for activating associated information as claimed in claim 4, wherein the feature matching module identifies the at least one related object related to the object in the environment feature association model according to the coordinate data or the location information corresponding to the object.

10. The object association system for activating associated information as claimed in claim 1, wherein the feature matching module identifies the at least one related object related to the object in the environment feature association model according to a weight of each of the digital environment feature, the physical environment feature and the text feature in the environment feature association model.

11. The object association system for activating associated information as claimed in claim 3,
wherein the system operation detecting module further detects an environment setting of the computer system when the object is opened,
wherein the feature analyzer and builder module further generates the digital environment feature according to the environment setting.

12. An object association method for activating associated information, comprising:
detecting and continually extracting digital environment information and physical environment sensor information corresponding to an object opened in a computer system;
generating a digital environment feature corresponding to the object according to the digital environment information corresponding to the object;
generating a physical environment feature corresponding to the object according to the physical environment sensor information corresponding to the object;
generating a text feature corresponding to the object according to text contents of the object;
building and updating an environment feature association model according to the digital environment feature, the physical environment feature and the text feature corresponding to the object;
storing the environment feature association model; and
identifying at least one related object related to the object according to the environment feature association model when the object is re-opened in the computer system.

13. The object association method for activating associated information as claimed in claim 12, further comprising:
generating and displaying related object reference information according to the at least one related object.

14. The object association method for activating associated information as claimed in claim 12, wherein the step of detecting and continually extracting the digital environment information and the physical environment sensor information corresponding to the object opened in the computer system comprises:
detecting the object opened in the computer system and at least another object simultaneously opened together with the object;
continually detecting a focus window in the computer system; and
receiving the physical environment sensor information corresponding to the object from at least one sensing device.

15. The object association method for activating associated information as claimed in claim 14, wherein the step of generating the digital environment feature corresponding to the object according to the digital environment information corresponding to the object comprises:
generating focus switching times and a switching time interval between the object and the at least one other object according to the detected focus window;
identifying at least one common working object corresponding to the object according to the focus switching times and the switching time interval between the object and the at least one other object; and
generating the digital environment feature according to the at least one common working object.

16. The object association method for activating associated information as claimed in claim 14, wherein the at least one sensing device at least comprises a positioning device configured for generating coordinate data or location information,
wherein the step of generating the physical environment feature corresponding to the object according to the physical environment sensor information corresponding to the object comprises:
taking the coordinate data or the location information received when the object is opened as the physical environment feature corresponding to the object.

17. The object association method for activating associated information as claimed in claim 12, wherein the step of generating the text feature corresponding to the object according to the text contents of the object comprises:
performing a word segmentation operation on the text contents of the object to generate at least one phrase; and
generating the text feature corresponding to the object according to a feature weight of each of the phases in the text content of the object.

18. The object association method for activating associated information as claimed in claim 12, wherein the step of generating the text feature corresponding to the object according to the text content of the object comprises:
performing a word segmentation operation on the text contents of the object to generate a plurality of phrases; and
generating the text feature corresponding to the object according to a feature weight of each of the phases in the text contents of the object and at least one associated phrase,
wherein the at least one associated phrase of each of the phrases is determined according to a minimum support degree and a minimum confidence index between the phrases.

19. The object association method for activating associated information as claimed in claim 14, wherein the step of identifying at least one related object related to the object according to the environment feature association model comprises:
identifying the at least one related object related to the object in the environment feature association model according to the at least one common working object corresponding to the object.

20. The object association method for activating associated information as claimed in claim 17, wherein the step of identifying at least one related object related to the object according to the environment feature association model comprises:
identifying the at least one related object related to the object in the environment feature association model according to the text feature corresponding to the object.

21. The object association method for activating associated information as claimed in claim 16, wherein the step of identifying at least one related object related to the object according to the environment feature association model comprises:
identifying the at least one related object related to the object in the environment feature association model according to the coordinate data or the location information corresponding to the object.

22. The object association method for activating associated information as claimed in claim 12, wherein the step of identifying at least one related object related to the object according to the environment feature association model comprises:
identifying the at least one related object related to the object in the environment feature association model according to a weight of each of the digital environment feature, the physical environment feature and the text feature in the environment feature association model.

23. The object association method for activating associated information as claimed in claim 15,
wherein the step of detecting and continually extracting the digital environment information and the physical environment sensor information corresponding to the object opened in the computer system comprises:
detecting an environment setting of the computer system when the object is opened,
wherein the step of generating the digital environment feature corresponding to the object according to the digital environment information corresponding to the object comprises:
generating the digital environment feature according to the environment setting.

24. A computer system, comprising:
a central processor, a random access memory, a storage device, an input device, a display device and a sensing device;
an operating system, stored in the storage device and executed by the central processor; and
an object association system, stored in the storage device and executed by the central processor, and the object association system comprising:
an environment recognition and monitor module, configured for detecting an object opened in a computer system, and continually extracting digital environment information and physical environment sensor information corresponding to the object;
a feature analyzer and builder module, configured for generating a digital environment feature corresponding to the object according to the digital environment information corresponding to the object, generating a physical environment feature corresponding to the object according to the physical environment sensor information corresponding to the object, and building an environment feature association model according to the digital environment feature, the physical environment feature and a text feature corresponding to the object;
a feature repository, configured for storing the environment feature association model; and
a feature matching module, configured for identifying at least one related object related to the object according to the environment feature association model when the object is re-opened.

25. A computer program product, comprising a plurality of program instructions, which when executed by a computer system, cause the computer system to execute the method according to claim 12.
